(19) United States
(12) Patent Application Publication
(10) Pub. No.: US 2018/0293842 A1
(43) Pub. Date: Oct. 11, 2018

(54) WAGER BASED GAMING APPARATUS

(71) Applicant: Huuuge Global Ltd., Lamaca (CY)

(72) Inventors: Anton Gauffin, Berlin (DE); Wojciech Wronowski, Szczecin (PL)

(21) Appl. No.: 15/480,465

(22) Filed: Apr. 6, 2017

(51) Int. Cl. G07F 17/32

(52) U.S. Cl. CPC G07F 17/3255; G07F 17/3213; G07F 17/3288; G07F 17/3274

(57) ABSTRACT

A gaming apparatus including a user interface, a memory and a processor. The memory includes non-transitory machine readable instructions and the processor is configured to execute the non-transitory machine readable instructions to: define a playing area on the user interface, wherein the playing area includes a primary game area and a secondary game area; identify at least a first team and at least a second team; execute a first game application in the primary game area by the first team; determine a credit associated with execution of the first game application by the first team; execute the first game application in the primary game area by the second team; determine a credit associated with the execution of the first game application by the second team; and apply, to a second game application in the secondary game area, the credit associated with execution of the first game application by the first team and the credit associated with the execution of the first game application by the second team.

### TECHNICAL FIELD

The present disclosure relates generally to a gaming apparatus; and more specifically, to a wager based gaming apparatus configured to enable a player to enjoy a game of chance, a wager based game or a betting related game.

### BACKGROUND

A wager based gaming apparatus has acquired an important place in an entertainment industry. Typically, a player performs one or more activities on the gaming apparatus to win different benefits of a wager based game in a single player mode. Further, the gaming apparatus is configured to promote multiplayer mode wherein multiple players participate as team members of a team and perform activities in a collaborative manner to defeat an opponent team.

Generally, the industry invests substantially in improving user experiences in the wager based games so that the players may find such games interesting, entertaining and remain involved in the playing activities for long intervals. In the wager based game, the player places a wager on an outcome of the game and attains the benefits including monetary or financial gains when the player wins the game. Typically, the wager based games are of very short duration for example, 1-2 minutes and it is very challenging for the industry to motivate the player to remain involved in the playing activities associated with the wager based game for long intervals.

In a known prior art solution, the player is given access to privileged benefits such as access to new levels, alternate games, super virtual powers and the like to encourage the player to play the wager based game for a relatively longer duration. However, the provisioning of privileged benefits fails to encourage the players when they play as the team members in the multiplayer mode as in the multiplayer mode, a motivation to play is dependent on his individual performance as well as on the performances of the other players of the team. For example, if the other players of the team are not performing well in the multiplayer mode, a specific team member may lose interest in playing the game and subsequently, quit the game. Similarly, if any of the team member of the team leaves the game in a mid-way, other team members may feel demotivated to continue the game. In addition, a play session value of the team may reduce if one or more of the team members decide to quit the multiplayer mode during a game play. As a result, the industry may lose substantial revenue opportunities.

Therefore, in light of the foregoing discussion, there exists a need to overcome the aforementioned drawbacks and encourage the players to remain motivated for playing the wager based games for long intervals.

### SUMMARY

The present disclosure seeks to provide a gaming apparatus.

The present disclosure seeks to provide a solution to the existing problem of reduced interaction of the players in the wager based games for a relatively longer duration. An aim of the present disclosure is to provide a solution that overcomes at least partially the problems encountered in prior art, and provides a gaming apparatus that substantially increases the player interests in the wager based games for a relatively longer duration.

In one aspect, an embodiment of the present disclosure provides a gaming apparatus comprising: a user interface; a memory, the memory including non-transitory machine readable instructions; and a processor, the processor being configured to execute the non-transitory machine readable instructions to: define a playing area on the user interface, wherein the playing area comprises a primary game area and a secondary game area; identify at least a first team and at least a second team; execute a first game application in the primary game area by the first team; determine a credit associated with execution of the first game application by the first team; execute the first game application in the primary game area by the second team; determine a credit associated with the execution of the first game application by the second team; and apply, to a second game application in the secondary game area, the credit associated with execution of the first game application by the first team and the credit associated with the execution of the first game application by the second team.

In another aspect, an embodiment of the present disclosure provides a a gaming apparatus comprising: a user interface; a memory, the memory including non-transitory machine readable instructions; and a processor, the processor being configured to execute the non-transitory machine readable instructions to: execute a first game application on the user interface of the gaming apparatus; generate a first credit associated with the execution of the first game application; open a second game application on the display of the gaming apparatus; automatically transfer the first credit generated during the execution of the first game application to the second game application; update the user interface to illustrate the transfer of the first credit to the second game application; execute the second game application; generate a second credit associated with execution of the second game application; and transfer the second credit to the first game application.

Embodiments of the present disclosure substantially eliminate or at least partially address the aforementioned problems in the prior art, and enables the players to remain addicted to the wager based games for a relatively longer duration while performing at an individual level. Consequently, the gaming industry observes a surge in financial gains due to the involvement of the players for longer durations.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a user interface of a gaming apparatus, in accordance with an embodiment of the present disclosure;

FIG. 2 is a schematic illustration of alternative user interface of the gaming apparatus, in accordance with an embodiment of the present disclosure;

FIG. 3 is a schematic illustration of a game loop logic, in accordance with an embodiment of the present disclosure; and

FIG. 4 is a schematic illustration of a use case of the user interface, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a gaming apparatus. The gaming apparatus includes a user interface, a memory, and a processor. The memory includes non-transitory machine readable instructions and the processor is configured to execute the non-transitory machine readable instructions to: define a playing area on the user interface, wherein the playing area comprises a primary game area and a secondary game area; identify at least a first team and at least a second team; execute a first game application in the primary game area by the first team; determine a credit associated with execution of the first game application by the first team; execute the first game application in the primary game area by the second team; determine a credit associated with the execution of the first game application by the second team; and apply, to a second game application in the secondary game area, the credit associated with execution of the first game application by the first team and the credit associated with the execution of the first game application by the second team.

In another aspect, an embodiment of the present disclosure provides a gaming apparatus comprising a user interface, a memory, and a processor. The memory includes non-transitory machine readable instructions and the processor is configured to execute the non-transitory machine readable instructions to: execute a first game application on the user interface of the gaming apparatus; generate a first credit associated with the execution of the first game application; open a second game application on the display of the gaming apparatus; automatically transfer the first credit generated during the execution of the first game application to the second game application; update the user interface to illustrate the transfer of the first credit to the second game application; execute the second game application; generate a second credit associated with execution of the second game application; and transfer the second credit to the first game application.

The present disclosure provides several advantages to the wager based gaming industry. Earlier, the player is not motivated to play the wager based games for longer durations and the player's involvement in the game is over as soon as the outcome of the wager based game is communicated to the player. The present disclosure enables the players to play for his bet as well as play for his team to gain additional benefits. As a result, the player's interest is reignited and the gaming industry observes an increase in the involvement time of the player in the wager based game.

In an embodiment, the player can interact with the user interface using a conventional pointing device such as a mouse, keyboard, joystick, a touch sensitive input device for providing inputs to the gaming apparatus. The gaming apparatus can include and is not limited to a personal computer, a hand-held computing device, a laptop, a mobile computer, a communication device such as a cell phone, a Pocket PC, and a PDA, a video slot machine, a video poker machine, a kiosk, a casino personal device, and typically includes many or all of the elements described above relative to the gaming apparatus.

A size of the primary game area and a size of the secondary game area on the user interface depends on the selection of the game which the player is playing on the user interface. For example, the size of the primary game area may be greater than the size of the secondary game area when the player is playing the first game application executed on the primary game area. Alternatively, the size of the secondary game area can be greater than the size of the primary game area when the player is playing the second game application executed on the secondary game area.

The first team includes a plurality of first team members and a second team includes a plurality of second team members. Each team member of the first and second teams have their respective user interfaces. At any instant of time, the team members from the first team can either play the first game application in the primary game area or the second game application in the secondary game area on their respective user interfaces. Further, an execution of the first game application in the primary game area by the first team comprises execution of the first game application by each of the first team members in their respective primary game areas. Similarly, the team members from the second team can either play the first game application in the primary game area or the second game application in the secondary game area on their respective user interfaces. Further, an execution of the first game application in the primary game area by the second team comprises execution of the first game application by each of the second team members in their respective primary game areas.

In an embodiment, the processor is configured to detect a request from one of the first team members or the second team members to play the first game application. Accordingly, the processor is configured to present an instance of the first game application corresponding to the requesting team member in the primary game area. The processor may be configured to limit a viewing of the presented instance of the first game application to the requesting team member. Further, the processor is configured to enable a presentation of the instance of the first game application corresponding to the requesting team member on a device of the requesting team member.

In an embodiment, the processor is configured to process multiple requests from different ones of the first team members and the second team members to play the first game application. The different ones of the first team members and the second team members may play the first game substantially at simultaneous intervals.

In an embodiment, the first game application is a wager based game such as a game of chance, a slot machine or any other betting game. The second game application is a team game such as a castle game, a strategy based game (e.g., a city building game) or another group game played specially in a multiplayer mode. The second game application encourages two or more teams to compete against each other to win the second game application.

The team members from the first team or the second team perform one or more actions in the wager based game. The one or more actions can include and is not limited to placing arbitrary wages for the slot machine, selecting a push type button or start spin button on the primary game area so that reels of the slot machine start spinning. Further, the processor is configured to render credits for the first team and the second team in the wager based game due to their respective actions. The credits earned by the first team and the second team in the wager based game are associated with first team and the second team respectively in the second game application wherein both the teams are competing against each other.

In an embodiment, the processor is configured to determine the credit associated with the execution of the first game application by the first team by calculating a number of points earned by each of the first team members from executing the first game application. Similarly, the processor is configured to determine the credit associated with the execution of the first game application by the second team by calculating a number of points earned by each of the second team members from executing the first game application.

In an embodiment, the processor is configured to associate an award with the first team when the credit associated with the execution of the first game application by the first team exceeds a pre-determined threshold value and associate the award with the second team when the credit associated with the execution of the first game application by the second team exceeds the pre-determined threshold value. The award can be in the form of opening of new levels in the first game application, power capsules to increase power levels for the players in the first game application. Otherwise, the award can be in the form of monetary awards for the players when their respective credits exceeds the pre-determined threshold value. In an embodiment, the processor is configured to render the player an access to control the user interface of the secondary game area based on the credits earned or win in the first game application executed on the primary game area.

In an embodiment, the slot machine game is executed in the primary game area and the castle game is executed in the secondary game area. The credits earned by the team members of the first and second teams in the slot game are converted into points that are utilized by the first and second teams respectively in the castle game. For example, each time a player of a specific team in the slot game has for example, 3 in a row or 3 scatters etc., the player of the specific team earns the credits which are accumulated for the specific team in the castle game. Additionally or alternatively, based on the credits of the first team, shield/strength/stamina points of the second team in the castle game are reduced and vice versa. This way each of the player in their own team contributes to a common cumulative win. In an embodiment, a team which can destroy for example, shield, immunity or strength points of the opponent team, may win the accumulated credits of the other team in their own castle. In addition, the winning team may also win slot machine credits of the opponent team.

In an embodiment, the processor is configured to process inter-transfer of credits among the teams depending on the value of the credits. For example, the processor is configured to transfer the credit associated with the second team to the first team when the credit associated with the execution of the first game application by the first team exceeds a pre-determined threshold value. Alternatively, the processor is configured to transfer the credits associated with the first team to the second team when the credit associated with the execution of the first game application by the second team exceeds the pre-determined threshold value. For example, if a team member of the first team hits a jackpot, the processor is configured to transfer the credits associated with the second team to the first team and the processor is configured to declare the first team a winner of the second game application instantly.

In an embodiment, the processor is configured to move a position of a graphical object associated with execution of the second game application in the secondary game area based on the credit associated with the execution of the first game application by the first team and the credit associated with the execution of the first game application by the second team. When the second game application is the castle game, the graphical object can be a visual representation of the credits and is stored in the castle game. For example, the graphical object can be in a form of a goal post, target area, shooting tanks, armour objects or other graphical objects that may move for the first team and the second team depending on the respective credits. The movement of the graphical object may increase strength of the teams in the second game application depending on the value of the respective credits.

In an embodiment, the processor is configured to compare the credit associated with execution of the first game application by the first team and the credit associated with the execution of the first game application by the second team and update a position of the graphical object based upon the comparison. The processor is configured to advance the position of the graphical object in a first direction when the comparison determines that the credit associated with the execution of the first game application by the first team is greater than the credit associated with the execution of the first game application by the second team. Alternatively, the processor is configured to advance the position of the graphical object in a second direction when the comparison determines that the credit associated with the execution of the first game application by the first team is less than the credit associated with the execution of the first game application by the second team. For example, when the second game application includes a virtual tug of war game between the first and second teams, the processor is configured to move the marked rope in a direction towards the team which has credits greater than his opponent's credits.

In an embodiment, the processor is configured to move the first graphical object towards a second graphical object associated with the first team in the secondary game area when the processor determines that the credit associated with the execution of the first game application by the first team is greater than the credit associated with the execution of the first game application by the second team. Further, the processor is configured to move the first graphical object towards a third graphical object in the secondary game area associated with the second team when the processor determines that the credit associated with the execution of the first game by the first team is less than the credit associated with the execution of the first game by the second team.

In an embodiment, the second game application can be a war game so that a team having greater number of credits in the first game application has an opportunity to advance/move symbols in the second game application. For example, the opportunity may include and is not limited to shoot an opponent or render a better set of weapons in the second game application.

In an embodiment, the processor is configured to determine an elapsed period of time from a start of the execution of the second game application and end the second game application if the elapsed period of time exceeds a pre-determined time value. In an embodiment, the second game application is configured to run for a predetermined amount of gaming period. The processor is configured to set the gaming period before initiation of the second game application. If a player leaves the first game application before the end of the predetermined amount of the gaming period of the second game application, the player of the specific team may not receive any credits from the first game application. As a result, the player remains motivated to stay until end of the gaming period of the second game application. In addition, the processor is configured to generate an alert to the player who has made up his mind to leave the first game application. The alert can be in a form of a message such as “there is only 2 minutes to go please continue playing or you might lose the money” and the like being displayed on the user interface of the respective player. The alert message acts as an inhibiting force for the specific player to leave the first game application before an expiry of the gaming period of the second game application.

In an embodiment, the processor is configured to enable the team members to control the activities in the second game application executed in the secondary game area through the activities performed on the first game application executed in the primary game area. For example, each time the player of the first team makes a progress in the first game application, the processor is configured to render advantages to the team members of the first team in the second game application. In other words, the processor is configured to generate actions in the secondary game area based on the actions performed by the team members of respective team in the primary game area.

In an embodiment, the processor is configured to convert the credit associated with execution of the first game application by the first team and the credit associated with the execution of the first game application by the second team into building material usable in the building game. For example, when the first game application is a slot machine and second game application is a SIMCITY type city building game wherein the player builds city for fun purposes, the credits earned by the players on the slot machine can be used to build cities in the city building game. The earned credit may be used to build homes, factories, purchase fire stations, power stations and the like that enhances the quality of life in the city.

The processor is configured to execute the first game application on the user interface of the gaming apparatus and generate a first credit associated with the execution of the first game application. The processor is configured to open a second game application on the display of the gaming apparatus and automatically transfer the first credit generated during the execution of the first game application to the second game application. The processor is configured to update the user interface to illustrate the transfer of the first credit to the second game application. The processor is configured to execute the second game application, generate a second credit associated with execution of the second game application and transfer the second credit to the first game application.

In an embodiment the second credit is used, in the first game application, during execution of the first game application. The first game application generates when executed the first credit. The first credit is used, in the second game application, during execution of the second game application. The second game application generates, when executed the second credit.

In an embodiment, the user interface is configured to display the first game application in a first state of the user interface and display the second game application in a second state of the user interface. The processor is configured to toggle the user interface between the first state and the second state when one of the first game application and the second game application is selected. Further, the processor is configured to present the first game application in a first portion of the user interface and the second game application in a second portion of the user interface, the first portion being larger than the second portion in the first state and the second portion being larger than the first portion in the second state.

In an embodiment, when the first game application is a slot game and the second game application is a city building computer and console video game, the credits generated while playing the slot game are transferred to the city building computer and console video game. Further, when a specific team attains a prescribed quality of life in the city building computer and console video game, the processor is configured to render the second credit to the specific team. The second credit can be in a form of stars, chips, winning points and the like. In an embodiment, the second credit may be used for unlocking multiple games in the slot game. In an embodiment, the quantum of the second credits depends on the maturity of the city as developed by the team and is allocated among the players of the team contributing to the development of the city. In case of single player, all the second credits go to one player. In case of multiple contributors to the city the second credits can be distributed among the team members based on set of rules.

In an embodiment, the processor is configured to render win-credits to the first or second team on winning the second game application. The win-credits thus obtained by the winning team may be distributed among its players. The win credits may be evenly distributed among the team members or distributed based on the contribution of the respective player to the win of the winning team. Further, if a specific player joins a team after the start of the second game application, the processor is configured to reward the specific player only a portion of the win-credits which are available to the team on winning the second game application. The portion of the win-credits can be proportional to the time for which the player was part of the team during the execution of the second game application in the secondary gaming area. Alternatively, if there are late joiners in the team, the team may lose some win-credits in the execution of the second game application as a punishment.

### DETAILED DESCRIPTION OF THE DRAWINGS

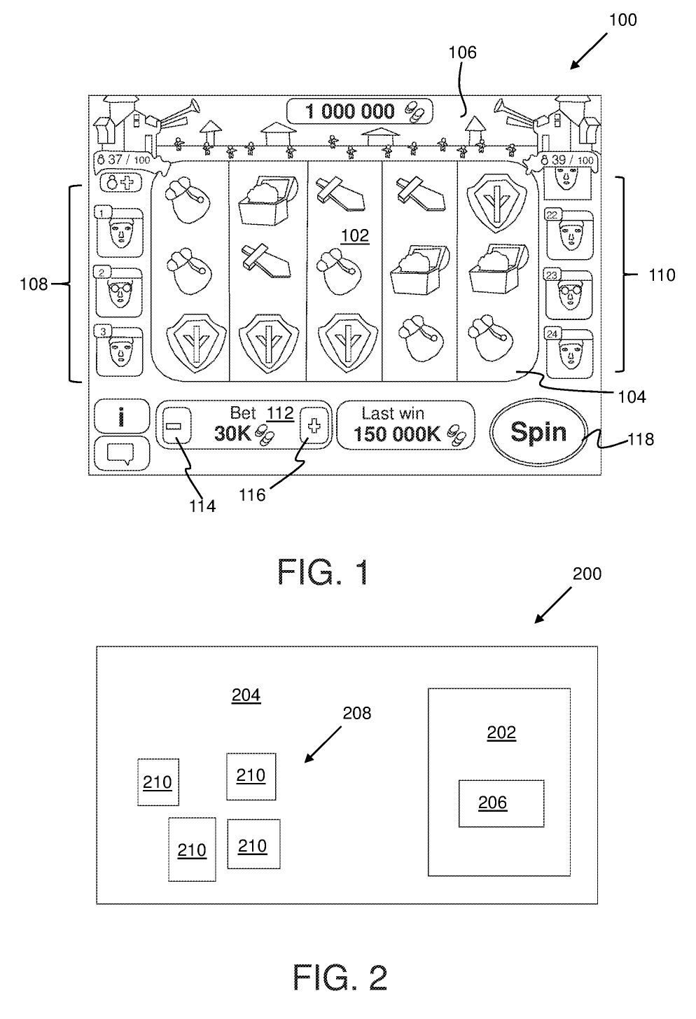

Referring to FIG. 1, illustrated is a schematic illustration of a user interface 100 of a gaming apparatus, in accordance with an embodiment of the present disclosure. The user interface includes 100 a playing area 102 which includes a primary game area 104 and a secondary game area 106. The playing area 102 includes a portion 108 and a portion 110, wherein the portion 108 indicates members of a first team and the portion 110 indicates members of a second team. The first and second teams may have respective five players. A slot machine is executed in the primary game area 104 and a castle game is executed in the secondary game area 106. A portion 112 indicates an amount of bet placed by the player and the player can increase or decrease the bet using the buttons 114 and 116. The player can select a spin button 118 to initiate playing on the slot machine.

Referring to FIG. 2, illustrated is a schematic illustration of alternative user interface 200 of the gaming apparatus, in accordance with an embodiment of the present disclosure. The user interface 200 includes a primary game area 202 and a secondary game area 204. A game of chance 206 is executed in the primary game area 202 and a smart city building game 208 is executed in the secondary game area 204. As indicated in the FIG. 2, the player is developing a city using the one or more buildings 210. The size of the secondary game area 204 is greater than the size of the primary game area 202 as the player is actively involved in the smart city building game 208. The size of the primary game area 202 can be greater than the size of the secondary game area 204 when the player selects the game of chance 206.

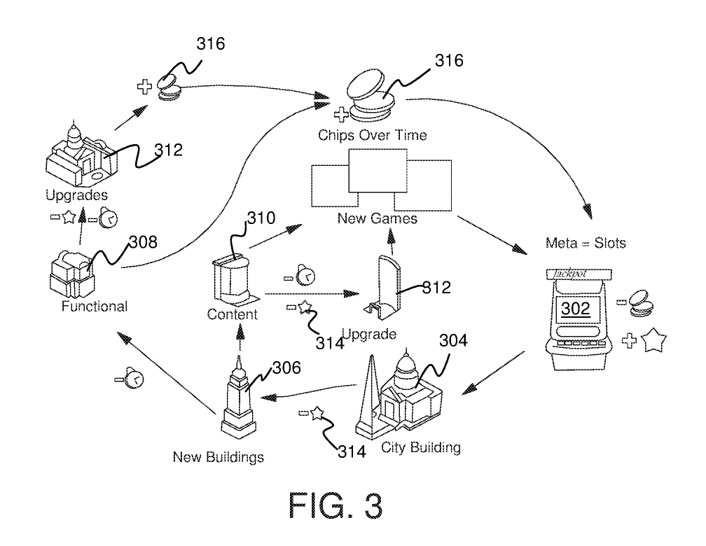

Referring to FIG. 3, illustrated is a schematic illustration of a game loop logic, in accordance with an embodiment of the present disclosure. The player selects the slot machine 302 and places one or more wages on the outcome of the slot machine 302. Based on the outcome of the slot machine 302, the player earns the credits which are accumulated for the city building game 304. The accumulated credits are used for developing new buildings 306 in the city, make these new buildings 306 functional using one or more functional components 308, and associating content value 310 such as price of the building. Further, the player may upgrade functional components 308 using an upgradation module 312. Further, addition of buildings 306 generates stars 314 for the player and any upgradation of the buildings or functional components generates chips 316 for the player. The stars 314 are used for unlocking new slot machine games for the player and chips 316 can be used as credits in the slot machine 302.

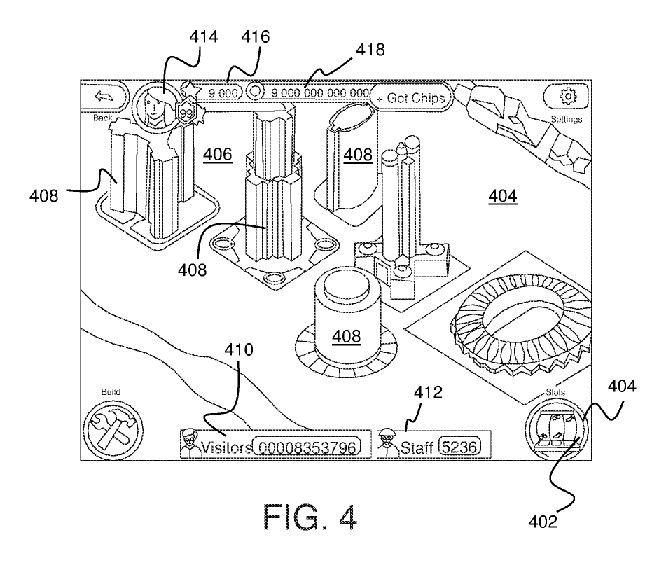

Referring to FIG. 4, illustrated is a schematic illustration of a use case of the user interface, in accordance with an embodiment of the present disclosure. A primary game area 402 executes a slot machine 404 and a secondary game area 404 executes a city building game 406. The secondary game area 404 includes one or more buildings 408 generated by the player in the city building game 406. A section 410 indicates a number of visitors which have visited the city and a section 412 indicates a number of staff members employed to maintain the city. A section 414 refers to the player involved in the building of the city. A section 416 indicates stars earned by the player and a section 418 indicates chips earned by the player.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A gaming apparatus comprising:
a user interface; and
a memory, the memory including non-transitory machine readable instructions; and
a processor, the processor being configured to execute the non-transitory machine readable instructions to:
define a playing area on the user interface, wherein the playing area comprises a primary game area and a secondary game area;
identify at least a first team and at least a second team;
execute a first game application in the primary game area by the first team;
determine a credit associated with execution of the first game application by the first team;
execute the first game application in the primary game area by the second team;
determine a credit associated with the execution of the first game application by the second team; and
apply, to a second game application in the secondary game area, the credit associated with execution of the first game application by the first team and the credit associated with the execution of the first game application by the second team.

2. The gaming apparatus according to claim 1, wherein the processor is configured to move a position of a graphical object associated with execution of the second game application in the secondary game area based on the credit associated with execution of the first game application by the first team and the credit associated with the execution of the first game application by the second team.

3. The gaming apparatus according to claim 2, wherein the processor is configured to compare the credit associated with execution of the first game application by the first team and the credit associated with the execution of the first game application by the second team and update a position of the graphical object based upon the comparison.

4. The gaming apparatus according to claim 3, wherein the processor is configured to advance the position of the graphical object in a first direction when the comparison determines that the credit associated with the execution of the first game application by the first team is greater than the credit associated with the execution of the first game application by the second team and in a second direction when the comparison determines that the credit associated with the execution of the first game application by the first team is less than the credit associated with the execution of the first game application by the second team.

5. The gaming apparatus according to claim 1, wherein the processor is configured to move a first graphical object towards a second graphical object associated with the first team in the secondary game area when processor determines that the credit associated with the execution of the first game application by the first team is greater than the credit associated with the execution of the first game application by the second team and move the first graphical object towards a third graphical object in the secondary game area associated with the second team when the processor determines that the credit associated with the execution of the first game by the first team is less than the credit associated with the execution of the first game by the second team.

6. The gaming apparatus according to claim 1, wherein the processor is configured to associate an award with the first team when the credit associated with the execution of the first game application by the first team exceeds a pre-determined threshold value and associate the award with the second team when the credit associated with the execution of the first game application by the second team exceeds the pre-determined threshold value.

7. The gaming apparatus according to claim 6, wherein the processor is configured to transfer the credit associated with the second team to the first team when the credit associated with the execution of the first game application by the first team exceeds a pre-determined threshold value and transfer the credits associated with the first team to the second team when the credit associated with the execution of the first game application by the second team exceeds the pre-determined threshold value.

8. The gaming apparatus according to claim 1, wherein the first team comprises a plurality of team members and execution of the first game application in the primary game area by the first team comprises execution of the first game application by each of the first team members, wherein the processor is configured to determine the credit associated with the execution of the first game application by the first team by calculating a number of points earned by each of the first team members from executing the first game application.

9. The gaming apparatus according to claim 8, wherein the second team comprises a plurality of team members and execution of the first game application in the primary game area by the second team comprises execution of the first game application by each of the second team members, wherein the processor is configured to determine the credit associated with the execution of the first game application by the second team by calculating a number of points earned by each of the second team members from executing the first game application.

10. The gaming apparatus according to claim 1, wherein the processor is configured to determine an elapsed period of time from a start of the execution of the second game application and end the second game application if the elapsed period of time exceeds a pre-determined time value.

11. The gaming apparatus according to claim 1, wherein the first game application is a slot game and the second game application is a castle and the graphical object is a representation of the credit and is stored in the castle.

12. The gaming apparatus according to claim 1, wherein the processor is configured to:
detect a request from one of the first team members or the second team members to play the first game application;
present an instance of the first game application corresponding to the requesting team member in the primary game area; and
limiting a viewing of the presented instance of the first game application to the requesting team member.

13. The gaming apparatus according to claim 12, wherein the processor is configured to enable a presentation of the instance of the first game application corresponding to the requesting team member on a device of the requesting team member.

14. The gaming apparatus according to claim 13, wherein the processor is configured to process multiple requests from different ones of the first team members and the second team members to play the first game application.

15. The gaming apparatus according to claim 14, wherein the processor is configured to enable the different ones of the first team members and the second team members corresponding to the multiple request to play the first game application substantially simultaneously.

16. The gaming apparatus according to claim 1, wherein the second game application is a building game and the processor is configured to convert the credit associated with execution of the first game application by the first team and the credit associated with the execution of the first game application by the second team into building material usable in the building game.

17. A gaming apparatus comprising:
a user interface;
a memory, the memory including non-transitory machine readable instructions; and
a processor, the processor being configured to execute the non-transitory machine readable instructions to:
execute a first game application on the user interface of the gaming apparatus;
generate a first credit associated with the execution of the first game application;
open a second game application on the display of the gaming apparatus;
automatically transfer the first credit generated during the execution of the first game application to the second game application;
update the user interface to illustrate the transfer of the first credit to the second game application;
execute the second game application;
generate a second credit associated with execution of the second game application; and
transfer the second credit to the first game application.

18. The gaming apparatus according to claim 17, wherein the first game application is a slot game and the second game application is a city building computer and console video game.

19. The gaming apparatus according to claim 17 wherein the user interface is configured to display the first game application in a first state of the user interface and display the second game application in a second state of the user interface, the processor being configured to toggle the user interface between the first state and the second state when one of the first game application and the second game application is selected.

20. The gaming apparatus according to claim 19, wherein the processor is configured to present the first game application in a first portion of the user interface and the second game application in a second portion of the user interface, the first portion being larger than the second portion in the first state and the second portion being larger than the first portion in the second state.
